(19) United States
(12) Patent Application Publication
(10) Pub. No.: US 2026/0050509 A1
(43) Pub. Date: Feb. 19, 2026

(54) Method For Finding And Erasing Errors Within A Mapping Process

(71) Applicant: Siemens Aktiengesellschaft, München (DE)

(72) Inventors: Swathi Shyam Sunder, Bengaluru (IN); Tobias Aigner, München (DE)

(73) Assignee: Siemens Aktiengesellschaft, München (DE)

(21) Appl. No.: 19/101,144

(22) PCT Filed: Jul. 28, 2023
(86) PCT No.: PCT/EP2023/071047

§ 371 Date: Feb. 4, 2025

(30) Foreign Application Priority Data
Aug. 4, 2022 (EP) 22188811.8

(51) Int. Cl. G06F 11/07

(52) U.S. Cl. CPC G06F 11/0793; G06F 11/073

(57) ABSTRACT

Various embodiments include a method for finding and erasing errors within a mapping process transforming an input file into a graph using a transformation instruction written in a graph mapping language and saving the graph in an output file. An example includes: acquiring the input file to be transformed into the graph by the mapping process; acquiring a mapping file written in the graph mapping language and comprising a plurality of transformation instructions for transformations of the input file by the mapping process; executing the transformation instruction in an order specified by the mapping file; checking whether a predetermined condition is satisfied for the particular transformation instruction to be executed and/or the result of the execution; executing a predetermined operation and/or outputting the transformation instruction executed and/or the result and/or the output file in dependence on the condition; and debugging the mapping file in correspondence to the input file.

### CROSS-REFERENCE TO RELATED APPLICATIONS

This application is a U.S. National Stage Application of International Application No. PCT/EP2023/071047 filed Jul. 28, 2023, which designates the United States of America, and claims priority to EP Application No. 22188811.8 filed Aug. 4, 2022, the contents of which are hereby incorporated by reference in their entirety.

### TECHNICAL FIELD

The present disclosure relates to mapping processes. Various embodiments of the teachings herein include systems and/or methods for finding and erasing errors within a mapping process.

### BACKGROUND

Mapping of data, in particular relational data, to graphs is usually achieved by the generation of mapping files which can be processed by a processor or an engine, respectively. The processor or the engine build at least a part of a mapping process, which is in particular configured as a computing device. The computing device reads or imports the mapping file and processes transformation instructions or mappings contained therein with data contained in an input file. The results are stored in graph databases and/or RDF files, where RDF stands for Resource Description Framework.

However, the mapping files used to convert the input file to the output file may contain errors. These errors may be syntactic, semantic, or even specific to the data. Such errors affect the operation of the mapping process. The search for such errors can be very time-consuming and tedious. In this regard, the search depends, for example, on a processor implementation and its error handling. The processor implementation can be configured in such a way that finding errors is made difficult and can often only be solved by a trial-and-error approach.

### SUMMARY

Various embodiments of the teachings herein may include systems and/or methods for finding and erasing errors within a mapping process. For example, some embodiments include a method which is configured to transform an input file (IDB) into a graph on the basis of at least one transformation instruction written in a graph mapping language and to save the graph in an output file (GDB), comprising: Acquisition by the mapping process of the input file (IDB), which is to be transformed into the graph; (S1) Acquisition by the mapping process of a mapping file (MF) written in the graph mapping language and comprising a plurality of the transformation instructions for the transformations of the input file (IDB) ; (S2) Execution of the transformation instruction in an order specified by the mapping file (MF); (S3) Checking whether a predetermined condition is satisfied for the particular transformation instruction to be executed and/or the result of the execution; (S4) Executing a predetermined operation and/or outputting the transformation instruction executed and/or the result and/or the output file in dependence on the condition; (S5) and Debugging the mapping file (MF) in correspondence to the input file (IDB) (S6).

In some embodiments, the predetermined operation determines a breakpoint at which the execution of the transformation instructions is interrupted, preferably controlled interruption of the execution can be carried out, execution progress and/or status could be tracked, sections in IDB and MF could be highlighted against the corresponding result in GDB.

In some embodiments, (R2) RML is used as the graph mapping language.

In some embodiments, the mapping process comprises an (R2) RML processor device (PR) by which the execution is performed.

In some embodiments, the checking whether the predetermined condition is fulfilled and/or the execution of the operation is performed by an (R2) RML debugger device (DB) which is connected to the (R2) RML processor device (PR) via a communication interface (CI).

In some embodiments, by means of an artificial intelligence the predetermined operation is determined and/or a transformation instruction fulfilling the condition is changed.

In some embodiments, in the event of fulfillment of the predetermined condition, a prompt is provided at a human-machine interface, by means of which the transformation instruction causing at least the condition can be changed.

In some embodiments, individual triples, which characterize the graph of the output file (GDB), are stored in a serialized form in said output file (GDB).

As another example, some embodiments include a computer program which is directly loadable into a memory of a computing device, comprising program means for executing one or more of the methods described herein when the program is executed in the electronic computing device.

As another example, some embodiments include a storage medium having electronically readable control information stored on it comprising at least one computer program configured to perform one or more of the methods described herein when the storage medium is used in a computing device.

### BRIEF DESCRIPTION OF THE DRAWINGS

The drawings show:

FIG. 1 shows a schematic flowchart of an example method of operating and debugging a mapping process incorporating teachings of the present disclosure; and.

FIG. 2 Shows a Schematic Flow Chart of an Example Method incorporating teachings of the present disclosure.

### DETAILED DESCRIPTION

To accelerate the process of transforming relational data in graph data, teachings of the present disclosure includes ways to detect errors automatically, not by trial-and-error approach. The transformation of relational data to graph data is important looking at all industrial processes since relational data often are the sort of data generated by the different measuring instruments and graph data are the ones an artificial Intelligence AI or any sort of steering machine may be working with. Moreover, graph structure is more suitable when data from different relational data sources need to be integrated.

### So, the Process of Transforming the Relational Data Generated by

sensors, cameras etc., representing the physical condition of a production line and a respective product precursor and/or an industrial environment, for example a production hall, to be monitored into graph data to be processed by a processor and/or an AI sets the pace for the future success of automated and/or AI steered industrial processes.

However, the AI is not always configured to work with the originally generated data, being relational data. Some AI operate with graph data, so in these cases the step of transforming the relational data into graph data is an important and essential step within the production line and determines the time and/or the energy necessary for production.

Some examples of the teachings herein include a method for finding and erasing errors within a mapping process, which is configured to transform an input file (IDB) into a graph on the basis of at least one transformation instruction written in a graph mapping language and to save the graph in an output file (GDB), comprising the following:
Acquisition by the mapping process of the input file (IDB), which is to be transformed into the graph; (S1)
Acquisition by the mapping process of a mapping file (MF) written in the graph mapping language and comprising a plurality of the transformation instructions for the transformations of the input file (IDB) ; (S2)
Execution of the transformation instruction in an order specified by the mapping file (MF) ; (S3)
Checking whether a predetermined condition is satisfied for the particular transformation instruction to be executed and/or the result of the execution; (S4)
Executing a predetermined operation and/or outputting the transformation instruction executed and/or the result and/or the output file in dependence on the condition (S5) ; and Debugging the mapping file (MF) in correspondence to the input file (IDB) (S6).

Teachings of the present disclosure include using the functions of a debugger for graph mapping languages, where one of these languages can be, for example, R2RML and/or RML in other terms “(R2) RML”—, respectively, but the methods described herein are not limited to a specific graph mapping language. Debuggers are known for programming languages, which enable a developer to execute the program code and interrupt it at desired points, for example, to check the current state of the program. Another function of a debugger is a line-by-line execution of the program code. This is important for finding and identifying errors. Furthermore, the program can be examined interactively by evaluating source code provided by the user during execution. Furthermore, the results computed up to that point based on the source code can be displayed.

In other words, the mapping file could be processed step by step, in particular line by line. Conditions are used, such as breakpoints, which take effect at certain conditions in the data, i.e., in the input file or the mapping file. In this way, for example, a controlled interruption of the execution can be carried out, so that what has been output so far can be analyzed. In some embodiments, the current execution status is displayed when the specified operation is performed, or the output file is output. If the mapping file is, for example, a source code of the mapping language, the columns and/or lines of the source code can be highlighted. Additionally, or furthermore, the output file, which is in particular an RDF output, can be displayed and generated.

The condition can, for example, describe how a transformation must look like, so that, for example, a type of data can only be transformed into a certain type of data. For example, names cannot be converted to sizes. If this happens, the condition can be fulfilled. The output file contains a graph, which is stored in the output file and contains processed data of the input file. These are e.g., combined as a triple.

Each triple represents a statement in which a subject and an object, formed from the data, are related to each other (relation). Relations are directed from the subject to the object and named with the predicate. For example, a certain size can be assigned to a certain name, and the predicate can be the verb “has”. Triples referring to the same subjects or objects form a semantic network, which is often represented in tabular or graphical form. Graphically speaking, each statement in RDF is a simple sentence.

The output file or the result may be provided via an interface of the mapping process or, if the mapping process is the computing device, is stored, for example, in a memory area of a memory device of the computing device. When the input files and/or the mapping file are acquired, they may be read, for example, into a memory storage section or a storage medium that can be connected to the computing device via an interface. In some embodiments, the input file or the mapping file is simultaneously stored, for example in a RAM memory of the computing device, during the acquisition.

R2RML and RML—“(R2) RML” stands for both or either one of them—are mapping specifications used to convert source data from various heterogenous sources to RDF format. For this, one or more R2RML and/or RML processor units are used. Typically, it is used in ETL pipelines. Several solutions exist to process the mappings. The available tools differ in various aspects, have different features and advantages as well as disadvantages. For instance, this includes interfaces to the tools, how a processor is used, for example as an API or as a graphical user interface or as a library, form of access input and output modes and/or supported databases. Likewise, the RDF generation and serialization time differ across the available tools.

Conventionally, Integrating the Structured Rdb-format Source Data corresponding to different domains and/or formats involves the use of ETL “Extract, Transform, Load” processes for mapping the structured data to RDF data especially by an ontology of a knowledge graph.

Teachings of the Disclosure Include Using the Functions of a debugger for graph mapping. Via a display device or a human-machine interface, different modes of interaction with the mapping process can be suggested to the user, so that, for example, a text-based and/or a graphics-based interaction is possible via the user interface. Thus, in text mode, for example by means of a command line, the user can initiate commands, or operations, such as setting a breakpoint in a particular line, tracking execution progress and status, by the method according to the invention. In some embodiments, the user can interact via a graphical user interface, where this can be provided, for example, as a stand-alone desktop app or as an add-on for an editor. For example, setting a breakpoint can be done by clicking with a mouse pointer on a corresponding line.

With such debugging and analysis possibilities, one advantage of the method according to the invention is that the analysis and processing of the input file and/or the mapping file can be carried out particularly efficiently, so that the mapping process can also be operated particularly efficiently. Thus, for example, a premature failure of the mapping process or the computing device can be avoided.

Instead of Trial and Error, the Methods Described Herein Provide a systematic approach to troubleshooting. This improves the work of developers and additionally increases the development speed, saving time and/or costs. When errors occur, it is easier to use the method according to the invention than to use smaller mapping files and/or manually construct data to find errors. Moreover, for developers using the mapping process, a learning curve may be flat. Furthermore, for example, for further use of the output file, for example in a production environment in which components are manufactured on the basis of the graph, particularly advantageous operation can be enabled.

In Some Embodiments, a Break Point Is Determined As the predetermined operation, at which the execution of the transformation instruction is interrupted. In other words, the execution of the transformation instructions takes place up to a certain transformation instruction, which is determined or characterized by the break point. In this case, the break point or the operation can be dependent on the result and/or the transformation instruction. This has the advantage that the method can be used to check in a particularly simple manner whether the specified condition is fulfilled.

In some embodiments, in the event of fulfillment of the specified condition or in the event of a deviation of a result calculated by means of the mapping file from a target value, an input prompt is provided to the human interface device, by means of which the transformation instruction causing at least the condition can be changed. In particular, the updated mapping file or the output file can be output by a display device and/or via a further interface when deviating from the target value or when fulfilling the predetermined condition, respectively. In other words, when the results deviate from the expected value, an editing means is provided which allows a user to edit the mapping file and/or additionally or alternatively also the input file, so as to avoid a misbehavior of the mapping process. The mapping process can be operated as error-free as reasonably possible by the method.

In some embodiments, the mapping process comprises an (R2) RML processor device through which the execution is performed. In other words, for example, a specialized chip is provided in the computing device, which may comprise, for example, a GPU (Graphics Processing Unit) and/or a TPU (Tensor Processing Unit) and/or a CPU (Central Processing Unit) with a special instruction set. In some embodiments, a separate memory area or a separate program code can be provided, which functions in particular as a parser for the input file into the output file. The process can be operated particularly efficiently.

In some embodiments, the checking and/or the execution of the operation is performed by a debugger device which is connected to the processor device via a communication interface. In other words, two independent devices are used in the method according to the invention, which may each be designed, for example, as a separate processor or computing device and/or as a separate software implementation. In this context, the two devices can be connected via a communication interface, which can be designed in software and, in particular, in hardware. For example, the debugging device can be performed on its own computing device, which is connected to the mapping process, for example by means of a network, and can thus control it for the analysis of the input file and/or the mapping file. The method can be used in a particularly flexible manner. A particularly large amount of energy can be saved, since the debugger device and the processor device can each be designed as specialized hardware.

In some embodiments, the predetermined operation is determined and/or a transformation instruction fulfilling the condition is changed by means of an artificial intelligence. In other words, a self-learning algorithm and/or a neural network are used to specify a predetermined operation to be performed based on the condition when performing the method. In some embodiments, if the condition is a deviation from an expected value of the output, respectively when creating the graph, the transformation instruction is changed by means of self-learning algorithm and/or neural network in particular such that the expected value is fulfilled. This results in the advantage that the method can be carried out with a particularly small number of user interventions. As a result, the mapping process can be operated particularly efficiently.

In some embodiments, (R2) RML is used as the graph mapping language. The method can be used particularly efficiently. It should be mentioned that the methods described herein are by no means limited to a specific graph mapping language but can be applied to any graph mapping language.

In some embodiments, individual triples, which characterize the graph of the output file, are stored in a serialized form in said output file. In other words, the data is serialized when the input file is converted to the output file using the graph mapping language. The output file can be provided, for example, in a particularly compact manner, as a result of which, for example, a memory requirement of a storage device is particularly low. Furthermore, there is the advantage that energy is not unnecessarily wasted when exchanging files with a further mapping process or a further computing device, for example via a computer network.

Some embodiments of the teachings herein include a computer program loaded in a memory of a computing device of the mapping process, which comprises program means for executing one or more of the methods described herein when the computer program is executed in the computing device. In this regard, advantages, and advantageous embodiments of the methods described herein are considered advantages and advantageous embodiments of the programs, and vice versa.

Some embodiments of the teachings herein include a storage medium comprising electronically readable control information stored thereon, the control information comprising at least one computer program as described herein and being configured to perform one or more of the methods presented herein when the storage medium is used in the computing device. In this regard, advantages, and advantageous embodiments of the storage media are to be regarded as advantages and advantageous embodiments of both the computer programs and the methods described herein, and vice versa in each case.

### The Teachings of the Present Disclosure Include Computer Programs

comprising program modules accessible from computer-usable or computer-readable medium storing program code for use by or in connection with one or more computers, processors, or instruction execution system. For the purpose of this description, a computer-usable or computer-readable medium can be any apparatus that can contain, store, communicate, propagate, or transport the program for use by or in connection with the instruction execution system, apparatus, or device. The medium can be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and DVD. Both processors and program code for implementing each aspect of the technology can be centralized or distributed (or a combination thereof) as known to those skilled in the art.

For use cases or use situations which may arise in carrying out the method and which are not explicitly described here, it may be provided that, in accordance with the method, an error message and/or a prompt for user feedback is output and/or a default setting and/or a predetermined initial state is set.

While the present teachings have been described in detail with reference to certain embodiments, it should be appreciated that the present disclosure is not limited to those embodiments. In view of the present disclosure, many modifications and variations would be present themselves, to those skilled in the art without departing from the scope of the various embodiments of the present disclosure, as described herein. The scope is, therefore, indicated by the following claims rather than by the foregoing description. All changes, modifications, and variations coming within the meaning and range of equivalency of the claims are to be considered within their scope. All advantageous embodiments claimed in method claims may also be apply to system/apparatus claims.

Until now, it has been a problem to operate a mapping process in such a way that an error analysis can be performed particularly efficiently, and thus, for example, graphs created by the mapping file are correct or the mapping process itself can be operated efficiently. The methods presented herein serve for operating the mapping process, which is configured in particular as a computing device, which is configured to convert an input file IDB into a graph by means of at least one transformation instruction, which is written in a graph mapping language, and to store it in an output file GDB. An example method comprises:

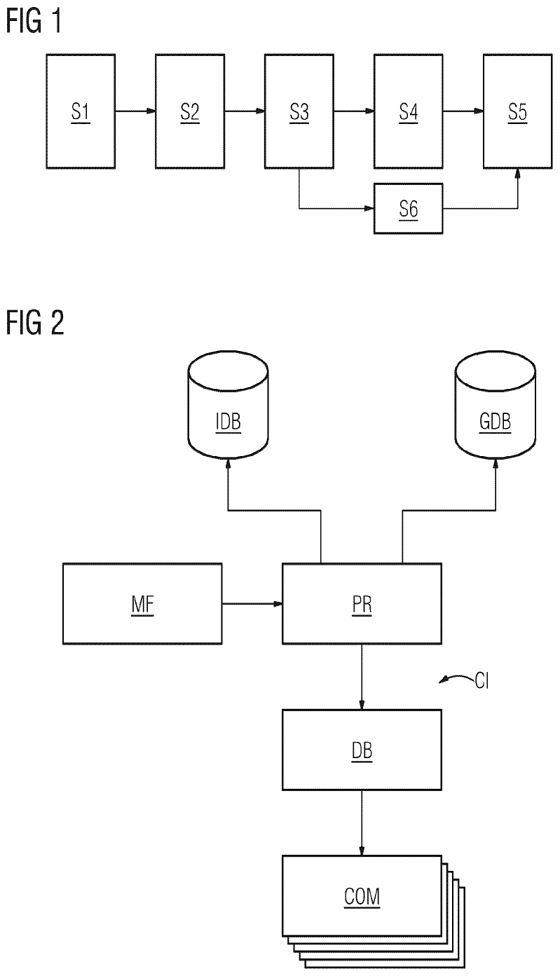

The sequence of steps is shown in FIG. 1, wherein in a first step S1 the input file IDB, which is to be converted or transformed into the graph, is acquired by the mapping process.

In a second step S2, a mapping file MF is acquired by the mapping process, which is written in the graph mapping language, and which comprises a plurality of transformation instructions, in particular to be executed successively, of the at least one transformation instruction for the transformation of the input file IDB into the graph file.

In a third step S3, execution of the transformation instruction in the order specified by the mapping file MF is performed by the mapping process.

In a fourth step S4, a check is performed to determine whether a predetermined condition is satisfied for the respective transformation instruction just executed and/or to be executed and/or the result of the execution of performance of the transformation criterion.

Subsequently, in a step S5, the execution of a predetermined operation and/or the output of a transformation instruction and/or of the result and/or of the output file GDB takes place depending on the fulfillment of the condition. In particular, if the condition is not fulfilled, the process continues with step S3.

The step of debugging the mapping file (MF) in correspondence to the input file (IDB) either runs after S5 or—as S6—parallel to steps S3, S4, and S5.

Further, in a step S6, debugging the mapping file (MF) in correspondence to the input file (IDB). This step either runs after S5 or in parallel to steps S3, S4, and S5.

Scenario 1—S1 to S5 are executed. If the final output contains errors, there is a need for debugging. This can be done through S6 after S3.

Scenario 2—S1 to S5 are being executed and there is a need to walk-through or trace the execution simultaneously. In this case, S6 happens in parallel to S3, S4 and S5.

By Advantageous Data Mapping, Data Migration, Data Integration, data transformation or data warehouse can be advantageously provided. In this context, it may be advantageous if the mapping process for the execution comprises an (R2) RML processor device PR. In some embodiments, the checking and/or the execution of the operation is performed by means of an (R2) RML debugger device DB, which is connected to the (R2) RML processor device via a communication interface.

FIG. 2 shows in a further schematic view a sequence of a possible embodiment of the method. The input data IDB is imported by the (R2) RML processor device PR, which is connected to the (R2) RML debugger device DB via the communication device CI. Furthermore, the mapping file MF is also imported by the processor device PR.

The (R2) RML debugger device DB can be configured in such a way that a user can determine, as a predetermined operation, a breakpoint in which the execution of the transformation instruction is interrupted.

In some embodiments, this is carried out as a controlled interruption of the execution, execution progress and/or status could be tracked, sections in IDB and MF could be highlighted against the corresponding result in GDB. In some embodiments, when the predefined condition is fulfilled, for example due to a deviation from a target value, an input request can be provided at a human-machine-interface-device, by which the transformation instruction fulfilling at least the condition can be changed.

In some embodiments, a self-learning algorithm or artificial intelligence can be used for this, which determines the specified operation and/or changes the transformation instruction fulfilling the condition. For this purpose, debugger commands COM can be provided in each case via the interface or by the self-learning algorithm. The debugger device DB uses these debugger commands COM to perform the operation, for example.

The presented methods allow the (R2) RML processor PR to parse the input file and outputs the mapping for the resulting output file, in particular an RDF files and/or a graph database GDB, providing callbacks for each executed line to allow the debugger to interrupt the execution of the mapping.

The (R2) RML debugger device DB can exchange callbacks with the (R2) RML processor device PR and tracks its status and provides methods for user interaction and control, such as input options for the debugger commands COM. The debugger commands COM may include breakpoints, execution flow, continue, step through and skip. Furthermore, printing source codes, listing source codes, displaying the resulting output file, displaying database contents, for example with columns and/or rows, as well as displaying the rows and/or columns of the source code is possible.

If a command, especially the given operation, is provided, the debugger device DB executes it and displays the result, for example, in a command line and/or in a graphical user interface. If no command is found, the execution of the program can be continued

Thus, a user can directly access the graph mapping by the presented method. Thus, in addition to checking the current state of the mapping, the user can, for example, update the mapping file particularly advantageously.

In some embodiments, time-travel debugging can be implemented. With this method it is possible to go back and forward in the mapping process. The advantage of this is that it is easy to rewind and repeat the steps without re-executing the mapping.

In some embodiments, (R2) RML can be used as the graph mapping language.

The presented methods, the computer programs, and the storage media allow a particularly simple processing of mapping files since errors occurring in them can be easily detected. Thus, the errors do not have to be tracked down by means of trial and error, but a systematic procedure is provided for this purpose. Thus, time and costs can be saved. Furthermore, developers who are familiar with the concept of a debugger have a flat learning curve when using the mapping process. Consequently, a debugger for graph mapping languages is presented.

What is claimed is:

1. A method for finding and erasing errors within a mapping process transforming an input file into a graph using a transformation instruction written in a graph mapping language and saving the graph in an output file, the method comprising:
acquiring the input file to be transformed into the graph by the mapping process;
acquiring a mapping file written in the graph mapping language and comprising a plurality of transformation instructions for transformations of the input file by the mapping process;
executing the transformation instruction in an order specified by the mapping file;
checking whether a predetermined condition is satisfied for the particular transformation instruction to be executed and/or the result of the execution;
executing a predetermined operation and/or outputting the transformation instruction executed and/or the result and/or the output file in dependence on the condition; and
debugging the mapping file in correspondence to the input file.

2. A method according to claim 1, wherein the predetermined operation determines a breakpoint at which the execution of the transformation instructions is interrupted.

3. A method according to claim 1, wherein the graph mapping language comprises (R2) RML.

4. A method according to claim 1, wherein the mapping process comprises an (R2) RML processor device performing the execution.

5. A method according to claim 4, wherein checking whether the predetermined condition is fulfilled and/or the execution of the operation is performed by an (R2) RML debugger device connected to the (R2 ) RML processor device via a communication interface.

6. A method according to claim 1, further comprising using an artificial intelligence to determine the predetermined operation and/or whether a transformation instruction fulfilling the condition is changed.

7. A method according to claim 1, further comprising, in the event of fulfillment of the predetermined condition, providing a prompt at a human-machine interface, by which the transformation instruction causing at least the condition can be changed.

8. A method according to claim 1, further comprising storing individual triples characterizing the graph of the output file in a serialized form in said output file.

9-10. (canceled)
